(19) United States
(12) Patent Application Publication
(10) Pub. No.: US 2010/0020288 A1
(43) Pub. Date: Jan. 28, 2010

(54) PROJECTION DISPLAY APPARATUS

(75) Inventors: Victor Yurlov, Suwon-si (KR); Anatoliy Lapchuk, Suwon-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Samsung Electro-Mechanics Co., Ltd., Suwon (KR)

(21) Appl. No.: 12/276,199

(22) Filed: Nov. 21, 2008

(30) Foreign Application Priority Data
Jul. 22, 2008 (KR) 10-2008-0070996

(51) Int. Cl. G02B 27/28; G03B 21/14; G02B 27/48

(52) U.S. Cl. 353/20

(57) ABSTRACT

Disclosed is a projection display apparatus including an optical modulator, configured to modulate a luminance of a beam; light sources in quantities of N, configured to output each beam having different polarization direction, N being a natural number and equal to or greater than 2; a lens unit, configured to allow each of the beams to be incident on an identical position of the optical modulator at a different incidence angle; a projection lens, configured to condense each of the N beams modulated and outputted from the optical modulator; an N-slit diaphragm, configured to allow some of the N beams to pass through the N-slit diaphragm; and N polarization filters, configured to perform a filtering of the beams having passed through N-slit diaphragm in different polarization directions. With the present invention, it is possible to suppress speckle noises which are generated on a video projected on a screen.

### CROSS-REFERENCE TO RELATED APPLICATION

This application claims the benefit of Korean Patent Application No. 10-2008-0070996, filed with the Korean Intellectual Property Office on Jul. 22, 2008, the disclosure of which is incorporated herein by reference in its entirety.

### BACKGROUND

1. Technical Field

The present invention relates to a projection display apparatus, more specifically to a projection display apparatus that can suppress speckle noises.

2. Description of the Related Art

Projection display apparatuses that employ a laser as their light sources are popular. The projection display apparatus can realize not only extra-large videos but also extra-small videos. It is very difficult that typical liquid crystal displays (LCD) or plasma display panels (PDP) realize the extra-large videos.

However, since such a projection display apparatus modulates a beam emitted from a laser light source per pixel and scans the beam to a screen in order to form a video, the formed video has a lower quality than those of other display apparatuses in which their screens directly emit rays of light.

One of the reasons that the formed video has the lower quality is resulted from a speckle noise or a speckle pattern generated on the video formed by a laser projection display apparatus.

A human eye has a limited resolution. The human eye quantizes an object to a plurality of points according to human resolution in order to see the object. For example, when a certain object is placed at the distance of about 3 m in front of a human, an eye of the human recognizes the surface of the object as points having the diameter of 1 mm.

Accordingly, if a screen is scanned at the distance of about 3 m, the diameter of any pixel are likely to be beyond 1 mm. This generates not the same luminance in the pixel but the speckle patterns. Human eyes recognize the speckle patterns and watch the formed video having noises. As a result, it is said that the quality of the video is significantly deteriorated.

The coherence of laser beams causes several interference patterns to be generated on a screen. If any distance between the interference patterns is beyond 1 mm, a user recognizes the interferences as noises.

### SUMMARY

Accordingly, the present invention, which is contrived to solve the aforementioned problems, provides a projection display apparatus that can use a plurality of lasers per color and suppress a speckle noise by vertically polarizing beams outputted from each of the lasers.

Other problems that the present invention solves will become more apparent through the following description.

To solve the above problems, an aspect of the present invention features a projection display apparatus.

According to an embodiment of the present invention, the projection display apparatus can include an optical modulator, configured to modulate a luminance of a beam; light sources in quantities of N, configured to output each beam having different polarization direction, N being a natural number and equal to or greater than 2; a lens unit, configured to allow each of the beams to be incident on an identical position of the optical modulator at a different incidence angle; a projection lens, configured to condense each of the N beams modulated and outputted from the optical modulator; an N-slit diaphragm, configured to allow some of the N beams to pass through the N-slit diaphragm; and N polarization filters, configured to perform a filtering of the beams having passed through N-slit diaphragm in different polarization directions.

The polarization directions of the beams can be vertical to each other.

The lens unit can include a condenser lens, and the two light sources can be placed such that each beam outputted from the two light sources passes through a different area in a curved surface of the condenser lens.

The N-slit diaphragm can be a double slit diaphragm, and the polarization filter is formed in two slits, respectively, to allow a modulation beam having a polarization direction to pass through the polarization filter. Here, the polarizations direction of the modulation beams passing through the polarization filter can be vertical to each other.

The N light sources can output each same color beam having an identical magnitude.

According to an embodiment of the present invention, the projection display apparatus can include light sources in quantities of N, configured to output each identical beam, N being a natural number and equal to or greater than 2; a polarization rotating plate, configured to allow N beams outputted from the N light sources to have different polarization directions by polarizing some of the N beams; an optical modulator, configured to modulate a luminance of an incident beam; a lens unit, configured to allow the N beams to be incident on an identical position of the optical modulator at a different incidence angle; a projection lens, configured to condense each of the N beams modulated and outputted from the optical modulator; an N-slit diaphragm, configured to allow some of the N beams to pass through the N-slit diaphragm; and N polarization filters, configured to perform a filtering of the beams having passed through N-slit diaphragm in different polarization directions.

If the N is 2, the two light sources can output each beam having an identical polarization direction, and the polarization rotating plate can polarize one of the two beams in a vertical direction.

The polarization rotating plate can be a half wave plate (HWP).

The lens unit can include a condenser lens. Here, the polarization rotating plate can be placed between any one of the two light sources and the lens unit.

The lens unit can include a condenser lens, and the two light sources can be placed such that each beam outputted from the light sources passes through a different area in a curved surface of the condenser lens. Here, the polarization rotating plate can be placed on a route of a beam passing through one of the different areas.

### BRIEF DESCRIPTION OF THE DRAWINGS

FIG. 1 is a block diagram showing the structure of a projection display apparatus display apparatus in accordance with an embodiment of the present invention;

FIG. 2 shows a shape of a micromirror constituting an optical modulator included in a projection display apparatus in accordance with an embodiment of the present invention;

FIG. 3 shows an optical modulator included in a projection display apparatus in accordance with an embodiment of the present invention;

FIG. 4 shows the structure of a projection display apparatus in accordance with an embodiment of the present invention; and

FIG. 5 shows the structure of a projection display apparatus in accordance with another embodiment of the present invention.

### DETAIL DESCRIPTION

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the spirit and scope of the present invention.

Terms such as “first” and “second” can be used in describing various elements, but the above elements shall not be restricted to the above terms. The above terms are used only to distinguish one element from the other. For instance, the first element can be named the second element, and vice versa, without departing the scope of claims of the present invention. The term “and/or” shall include the combination of a plurality of listed items or any of the plurality of listed items.

When one element is described as being “connected” or “accessed” to another element, it shall be construed as being connected or accessed to another element directly but also as possibly having yet another element in between. On the other hand, if one element is described as being “directly connected” or “directly accessed” to another element, it shall be construed that there is no other element in between.

The terms used in the description are intended to describe certain embodiments only, and shall by no means restrict the present invention. Unless clearly used otherwise, expressions in the singular number include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

Unless otherwise defined, all terms, including technical terms and scientific terms, used herein have the same meaning as how they are generally understood by those of ordinary skill in the art to which the invention pertains. Any term that is defined in a general dictionary shall be construed to have the same meaning in the context of the relevant art, and, unless otherwise defined explicitly, shall not be interpreted to have an idealistic or excessively formalistic meaning.

Hereinafter, some embodiments of the present invention will be described in detail with reference to the accompanying drawings. Identical or corresponding elements will be given the same reference numerals, regardless of the figure number, and any redundant description of the identical or corresponding elements will not be repeated.

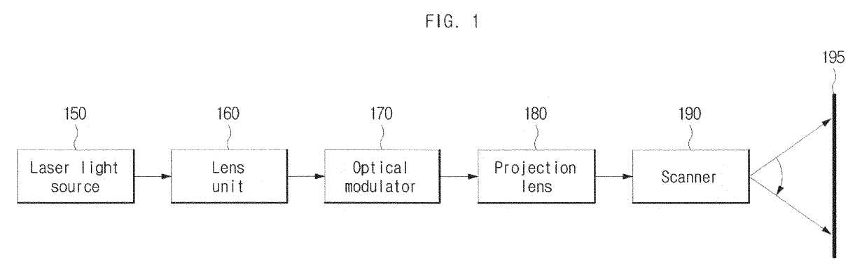

FIG. 1 is a block diagram showing the structure of a projection display apparatus display apparatus in accordance with an embodiment of the present invention.

As shown in FIG. 1, the projection display apparatus in accordance with an embodiment of the present invention can include a laser light source 150, a lens unit 160, an optical modulator 170, a project lens 180, and a scanner 190.

The laser light source 150 can employ a laser diode, a solid laser, a gas laser, or a liquid laser. The prevent invention is not limited to these types of laser.

The lens unit 160 can include a condenser lens, a collimating lens, and a cylinder lens. The condenser lens can condense a beam of light emitted from a light source. The collimating lens can collimate the condensed beam to a parallel beam. The parallel beam refers to a traveling beam, all light streams of which travel in parallel.

The cylinder lens refers to an optical element which converts a collimated beam to a line beam. This is because if the optical modulator 170 included in the projection display apparatus of the present invention is a one-dimensional optical modulator, a one-dimensional line beam may be required to be incident on the optical modulator 170.

The one-dimensional optical modulator 170 can have a plurality of micromirrors that ate arranged in a one-dimensional line shape. In particular, each of the micromirrors can correspond to each pixel of a video displayed on the screen 190. The plurality of micromirrors can be arranged in a line to form the optical modulator 170. Alternatively, each of the micromirrors can be configured or arranged in various ways.

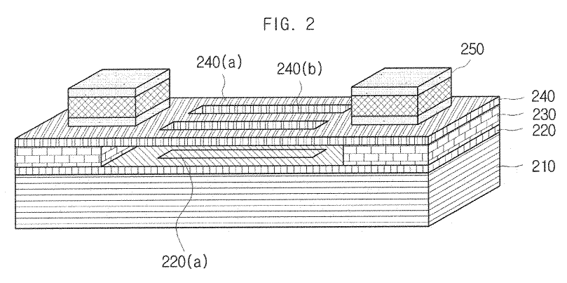

The structure of an optical modulator having upper and lower reflection layers modulating a beam of light in various optical modulators will be described later with reference to FIG. 2

If line-shaped beams, not each point-shaped beam, are time-dividedly inputted into each micromirror of pixel unit forming the line-shaped optical modulator 170, each of the micromirrors can modulate the line-shaped beams, and the optical modulator 170 formed to include the plurality of micromirrors can output the modulated one-dimensional line beams.

The modulation beams outputted from the overall part of the optical modulator 170 can pass through the projection lens 180 and be reflected by a mirror included in the scanner 190. Finally, the modulation beams can form one linear scanning line on the screen 195. Accordingly, if this linear scanning line is successively scanned on the screen 195, a two-dimensional video can be completely formed.

In other words, the beams modulated by the optical modulator 170 can be inputted into the scanner 190 through the projection lens 180. The scanner 190 can project a line beam in a predetermined direction onto the screen 195 in order to form a two-dimensional video.

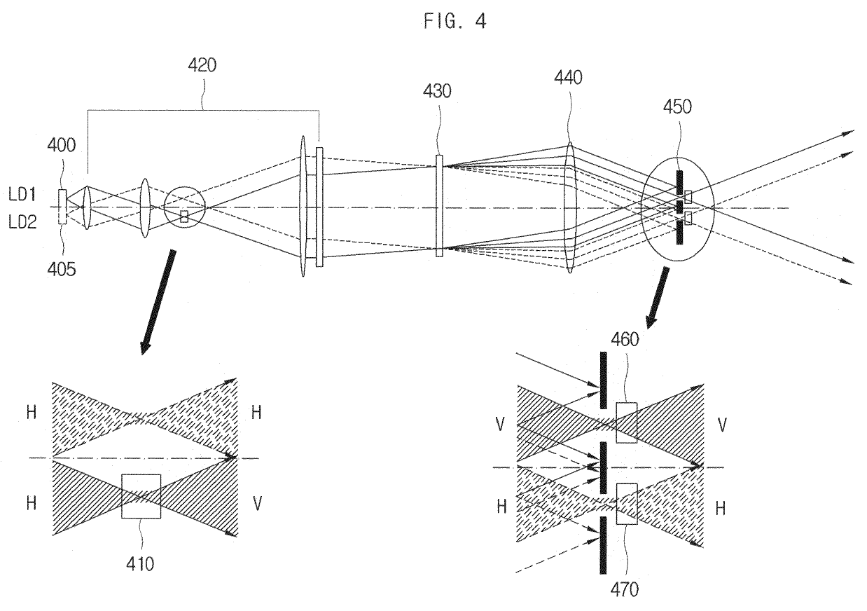

The scanner 190 can reflect the modulation beams modulated and outputted from the optical modulator 170 at a predetermined angle to project the beams to the screen 195. For example, if a vertically directional line beam outputted from the optical modulator 170 is scanned in a horizontal direction of the screen 195, a two-dimensional video can be completely formed. This will be described in detail with reference to FIG. 4.

At this time, the predetermined angle can be adjusted according to a scanner control signal inputted from a video processing unit (not shown). The scanner control signal can be synchronized with a video control signal and rotate the scanner 190 at an angle such that a modulated line beam can be projected at the angle onto a position of a vertical (or horizontal) scanning line on the screen 195, corresponding to the video control signal. The canner control signal can have information related to a rotating angle and a rotating speed. The scanner 190 can scan a beam to a position at a point of time according to the rotating angle and the rotating speed. The scanner 190 can employ a polygon mirror, a rotating bar, or galvano mirror.

A video processing unit, which is not shown in FIG. 1, can control the laser light source 150, the optical modulator 170, and the scanner 190. In particular, the video processing unit can include a micro processor and be electrically connected to elements of a display apparatus to output a signal for controlling the elements.

As described above, the video processing unit can also transmit a scanner control signal in order to control the scanning of a one-dimensional video outputted from the optical modulator 170 from a left side to a right side.

Moreover, the video processing unit can control the optical modulator 170 to generate a one-dimensional video having a desired luminance by changing each position of the micromirrors constituting the optical modulator 170 to correspond to a video signal.

The projection display apparatus of the present invention may generate a speckle noise on a video projected onto a screen due to using a laser light source. In particular, since a laser beam, as described above, is a coherent beam of light, this may cause the speckle noise to be generated on the projected video. If there are enough speckle noises for a human eye to recognize, the quality of video may be significantly deteriorated.

Accordingly, the projection display apparatus of the present invention can use a plurality of laser light sources per color instead of one laser light source. For example, a plurality of laser diode arrays can be used, and beams emitted from the laser diode arrays may be required to be overlapped on a screen.

In this case, the overlapped beams can be the same color beams having different polarization directions only. N beams that are uncorrelated to each other are overlapped on a screen, and accordingly, the speckle noises may be suppressed by \sqrt{N} times. In other words, if N uncorrelated beams are overlapped, the speckle noises of video may drop by using \sqrt{N} as a decreasing factor.

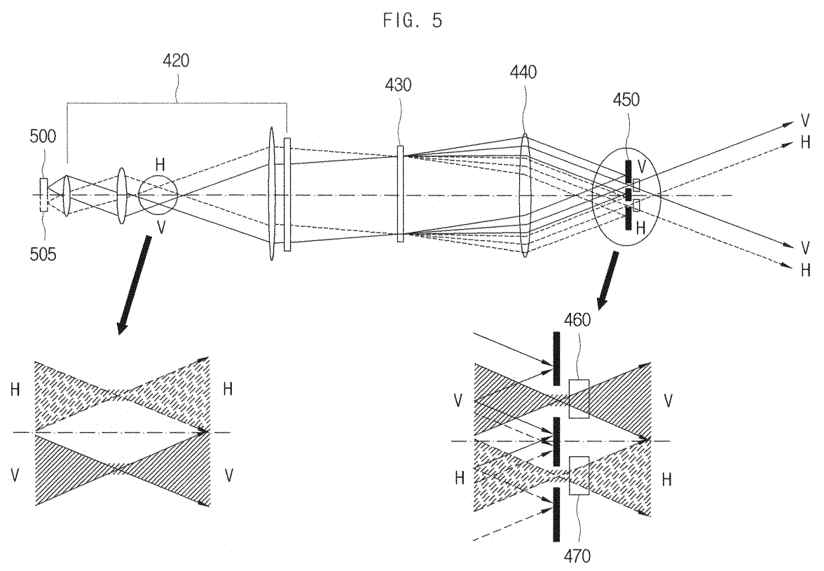

Accordingly, the projection display apparatus of the present invention can use laser diodes and scan the same beams to an identical position of a screen. At this time, a polarization rotating plate and a polarization filter can be included in the projection display apparatus in order to scan uncorrelated beams of light. The arrangement and features of the polarization rotating plate will be described in detail with reference to FIG. 4 and FIG. 5.

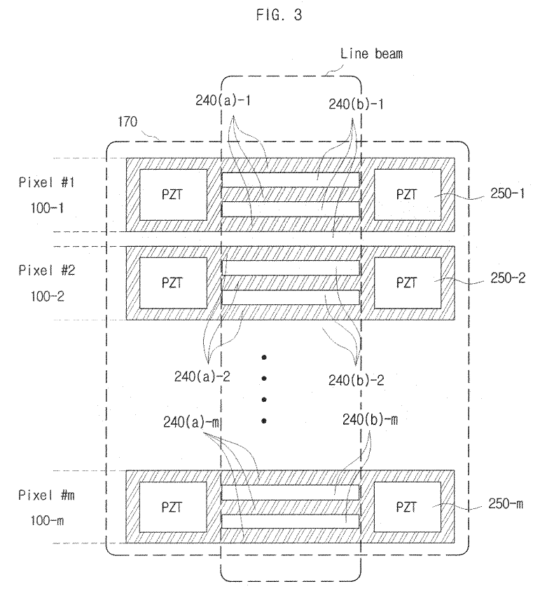

Hereinafter, the configuration and the driving principle of a one-dimensional optical modulator included in the projection display apparatus of the present invention will be firstly described with reference to FIG. 2 and FIG. 3.

FIG. 2 shows a shape of a micromirror constituting an optical modulator included in a projection display apparatus in accordance with an embodiment of the present invention.

As shown in FIG. 2, which depicts one of a plurality of micromirrors arranged in a line to constitute an optical modulator, there shown are a substrate 210, an insulation layer 220, a sacrificial layer 230, a ribbon structure 240 and a piezoelectric element 250.

The substrate 210 can be a commonly used semiconductor substrate, and the insulation layer 220 can be deposited as an etch stop layer. The insulation layer 220 can be formed from a material with a high selectivity to the etchant (i.e. an etching gas or an etching solution) that etches the material used as the sacrificial layer 230. Here, a lower reflective layer 220(a) can be formed on the insulation layer 220 to reflect incident beams of light.

The sacrificial layer 230 can support the ribbon structure 240 at opposite sides such that the ribbon structure 240 can be spaced by a constant gap from the insulation layer 220, and form a space in a center part.

The ribbon structure 240 can create diffraction and interference in the incident light to perform optical modulation of signals. The ribbon structure 240 can be formed in a plurality of ribbon shapes, or can include a plurality of open holes 240(b) in the center part of the ribbons. The piezoelectric element 250 also controls the ribbon structure 240 to move upwardly and downwardly according to upward and downward, or leftward and rightward contraction or expansion levels generated by the voltage difference between the upper and lower electrodes. Here, the lower reflective layer 220(a) can be formed corresponding to the open hole formed in the ribbon structure 240.

For example, in case that the wavelength of a beam of light is λ, a first voltage can be supplied to the piezoelectric elements 250. At this time, the first voltage can allow the gap between an upper reflective layer 240(a), formed on the ribbon structure 240, and the lower reflective layer 220(a), formed on the insulation layer 220, to be equal to (2l)λ/4, being a natural number. In the case of a 0^{th}-order diffracted beam of light, the overall path length difference between the light reflected by the upper reflective layer 240(a) and the light reflected by the lower reflective layer 220(a) can be equal to lλ, so that constructive interference occurs and the diffracted light renders its maximum luminance. In the case of +1^{st} or −1^{st} order diffracted light, however, the luminance of the light can be at its minimum value due to destructive interference.

A second voltage can be supplied to the piezoelectric elements 250. At this time, the second voltage can allow the gap between an upper reflective layer 240(a), formed on the ribbon structure 240, and the lower reflective layer 220(a), formed on the insulation layer 220, to be equal to (2l+1)λ/4, l being a natural number. In the case of a 0^{th}-order diffracted beam of light, the overall path length difference between the light reflected by the upper reflective layer 240(a) formed on the ribbon structure 240 and the light reflected by the insulation layer 220(a) can be equal to (2l+1)λ/2, so that destructive interference occurs, and the diffracted light renders its minimum luminance. In the case of +1^{st} or −1^{st} order diffracted light, however, the luminance of the light can be at its maximum value due to constructive interference.

As a result of such interference, the micromirror can load a signal for one pixel on the beam of light by adjusting the quantity of the reflected or diffracted light. Although the foregoing describes the cases in which the gap between the ribbon structure 240 and the insulation layer 220 is (2l)λ/4 or (2l+1)λ/4, it shall be obvious that a variety of embodiments can be applied to the present invention, in which adjusting the gap between the ribbon structure 240 and the insulation layer 220 is able to control the luminance of light interfered by diffraction and/or reflection of the incident light.

Although a diffractive optical modulator has been described with reference to FIG. 2, the diffractive optical modulator is merely an optical modulator included in the projection display apparatus in accordance with an embodiment of the present invention. It shall be obviously that the diffractive optical modulator can be replaced with a transmissive or reflective optical modulator.

The piezoelectric optical modulator has also been described with reference to FIG. 2. Similarly, this is merely an example of an optical modulator in accordance with an embodiment of the present invention. It shall be obviously that the piezoelectric optical modulator can be replaced with an electrostatic optical modulator.

FIG. 3 shows an optical modulator included in a projection display apparatus in accordance with an embodiment of the present invention.

Referring to FIG. 3, the optical modulator 130 can be configured to include m micro-mirrors 100-1, 100-2, . . . , and 100-m, each of which corresponds to a first pixel (pixel #1), a second pixel (pixel #2), . . . , and an mth pixel (pixel #m), respectively, m being a natural number. The optical modulator 130 can process image information with respect to 1-dimensional images of vertical or horizontal scanning lines (which are assumed to consist of m pixels), while each micromirror 100-1, 100-2, . . . , and 100-m can process one pixel among the m pixels constituting the vertical or horizontal scanning line.

The vertical or horizontal scanning lines can be formed by one-dimensional modulation beams, to which line beams are modulated in units of pixel, the line beams being incident in the lengthwise direction in the optical modulator in which the micromirrors, as shown in FIG. 3, are arranged in a line.

Accordingly, the optical modulator 170 can accurately output the modulation beams corresponding to video information when the size of a line beam emitted from the lens unit 160 is accurately controlled.

The beam of light reflected or diffracted by each micromirror can be later projected as a 2-dimensional image onto the screen 195 by a scanner 190. For example, in the case of an image having a VGA resolution of 640×480, modulation can be performed 640 times for one surface of the scanner 190 for 480 vertical pixels, to thereby generate 1 frame on the screen 195 per surface of the scanner 190.

In the present embodiment, it is assumed that the number of holes 240(b)-1 formed in the ribbon structure 240 is two. Because of the two holes 240(b)-1, three upper reflective layers 240(a)-1 can be formed in an upper part of the ribbon structure 240. In the insulation layer 220, two lower reflective layers can be formed in correspondence with the two holes 240(b)-1. Another lower reflective layer can also be formed in the insulation layer 220 in correspondence with the gap between the first pixel (pixel #1) and the second pixel (pixel #2). Accordingly, the number of the upper reflective layers 240(a)-1 can be identical to that of the lower reflective layers per pixel, and it can be possible to control the luminance of modulation light by using the 0^{th}-order diffracted light or ±1^{st}-order diffracted light.

FIG. 4 shows the structure of a projection display apparatus in accordance with an embodiment of the present invention.

As shown in FIG. 4, the projection display apparatus can include light sources 400 and 405, a lens unit 420, an optical modulator 430, a projection lens 440, a diaphragm 450.

If the optical modulator 430 is the one-dimensional optical modulator described with reference to FIG. 2 and FIG. 3, the projection display apparatus can further include a scanning device, such as a galvano mirror, in order to display two-dimensional video on a screen as described with reference to FIG. 1. To evade the point of the present invention, the scanning device will be omitted.

The light sources 400 and 405 can employ laser diode(LD). As described with reference to FIG. 1, the present invention is not limited to the laser diode.

Although FIG. 4 shows that the projection display apparatus includes LD1 and LD2, the number of light sources is not limited to FIG. 4. Hereinafter, it is assumed that the projection display apparatus includes the LD1 400 and the LD2 405.

The LD1 400 and LD2 405, which are placed at different positions, can emit beams having the same beam properties such as color and power. Moreover, the beams outputted from the LD1 400 and the LD 405, respectively, can have the same polarization directions.

For example, the LD1 400 and the LD2 405 can output beams that are polarized in the 3 o'clock-9'clock (i.e. horizontal) direction with respect to the original forwarding direction of the beams. The LD 1 400 and the LD2 405 can output beams that are polarized in one direction by using a method of attaching a polarization filer in the front of the LD1 400 and the LD2 405.

In this case, if the LD1 400 and the LD2 405 are placed adjacently to each other and a polarization filter is attached as one body in the front of the LD1 400 and LD2 405, two beams polarized in one direction can be outputted from the LD1 400 and LD2 405.

The beams outputted from the LD1 400 and LD2 405, respectively, can travel to the lens unit 420.

The lens unit 420 can include a condenser lens, a collimating lens, and a cylinder lens. The condenser lens can condense the beams emitted from the LD1 400 and LD2 405.

The condenser lens can be placed such that the beams outputted from the LD1 400 and the LD2 405 pass through each different side of the condenser lens. For example, as shown in FIG. 4, the beam outputted from the LD1 and the beam outputted from the LD2 can pass through an upper side and a lower side, respectively, of an optical axis of the condenser lens.

The condenser lens can have symmetric form with respect to the optical axis. The beams outputted from the LD1 and the beam outputted from the LD2, respectively, can travel and pass through the collimating lens and the cylinder lens before being incident on the optical modulator 430.

The polarization rotating plate 410 can be placed between the condenser lens and the collimating lens in the projection display apparatus in accordance with an embodiment of the present invention. In particular, if a first beam (represented by a full line) and a second beam (represented by a dotted line) refer to the beam outputted from the LD1 400 and the beam outputted from the LD2 405, respectively, before passing through the condenser lens, the polarization rotating plate 410 can be placed such that only one beam of the first beam and the second beam is polarized. As shown in FIG. 4, the polarization rotating plate 410 can be placed such that only the second beam, which is the beam outputted from the LD1 400, passes through the polarization rotating plate 410.

The beams outputted from the LD1 400 and the LD2 405, respectively, have already been polarized in the same direction (i.e. the horizontal direction in the above example). Since only one of the two beams is polarized, the two beams can have different polarization direction.

The polarization rotating plate 410 can be a half wave plate (HWP). The HWP can be a kind of thin compensating plate made of an optical anisotropic crystal which creates birefringence. If a beam having been polarized in one direction passes through the HWP, the polarization direction of the beam may be rotated by π/2, which is 90 degree.

Accordingly, as the beam outputted from the LD1 400 passes through the HWP, the original polarization direction can be rotated in a vertical (i.e. 12 o'clock-6 o'clock) direction as shown in FIG. 4. As a result, the beam outputted from LD1 400 can have a polarization direction that is vertical to that of the beam outputted from the LD2 405.

Therefore, after passing through the HWP, the beam traveling from the LD1 400 and the beam traveling from the LD2 405, respectively, may not interfere with each other because the beams have different polarization directions.

Thereafter, the beams can be incident on the optical modulator 430.

If the optical modulator 430 is the one-dimensional optical modulator described with reference to FIG. 2 and FIG. 3, a beam can be converted to a line beam by passing through a cylinder lens. Then, the line beam can be incident on a plurality of micromirrors included in the optical modulator 430.

The two beams have been emitted from the LD1 400 and the LD2 405, respectively, and can be incident on the optical modulator 430 via the lens unit 420. Accordingly, their incidence angles may be different from each other. Therefore, even though the two beams can travel from a left side and a right side of FIG. 4, the traveling routes of the two beams may be not identical to each other.

When the beams are modulated in units of pixel by the optical modulator 430, only the luminance of the beams can be modulated. This can allow two modulation beams having different polarization directions to be outputted from the optical modulator 430 and to travel to the project lens 440. The two modulation beams having different polarization directions can have the luminance that is identically modulated.

The two modulation beams having passed through the projection lens 440 can pass through the diaphragm 450. The diaphragm 450 can be a double-slit diaphragm having two slits. The slits can be placed such that the beam (represented by the full line) outputted from the LD 1 400 and the beam (represented by the dotted line) outputted from the LD2 405 can pass through different slits.

A polarization filter can be placed in back of each slit. Each of the polarization filters can be configured to allow the beams polarized in different directions to pass through the polarization filters. For example, in FIG. 4, an upper polarization filter 460 can be a horizontal block filter which allows only the beam (represented by the full line) traveling from the LD1 400 to pass through the horizontal block filter. Accordingly, the horizontally polarized beam (represented by the dotted line) traveling from the LD2 405 may not be able to pass through the horizontal block filter 460.

Inversely, a lower polarization filter 470 can be a vertical block filter which allows only the beam (represented by the dotted line) traveling from the LD2 405 to pass through the vertical block filter. Accordingly, the vertically polarized beam traveling from the LD1 400 may not be able to pass through the vertical block filter 470.

The two beams having passed through the diaphragm 450 can have different polarization directions but have the same outputs and luminance values of pixel unit.

Accordingly, the two beams can be overlapped on a screen. Although the two beams pass through different slits of the diaphragm 450, the difference between both of the slits is very small. Accordingly, when the beams having passed through each slit are expanded and projected on the screen, the beams can be overlapped.

If the two same beams having polarization directions that are vertical to each other are projected on the screen, the aforementioned speckle noises can be suppressed. In particular, it can be possible to suppress by \sqrt{2} times the speckle noises, which are considered as some problems in the projection display apparatus using a laser beam having coherence.

In general, if N light sources are used, the speckle noises can be suppressed by \sqrt{N} times.

FIG. 5 shows the structure of a projection display apparatus in accordance with another embodiment of the present invention.

As shown in FIG. 5, the projection display apparatus can have the same structure as that of FIG. 4 without a polarization rotating plate.

The projection display apparatus in accordance with another embodiment of the present invention can include a LD1 500 and a LD2 505. Beams outputted by the LD1 500 and the LD2 505 can have the same luminance and color but be polarized vertically to each other.

Accordingly, the two beams that are polarized vertically to each other can pass through the lens unit 420, the optical modulator 430, and the projection lens 440 without a polarization rotating plate. For example, a vertically polarized beam (represented by a full line) outputted from the LD1 500 can pass through the lens unit 420 before being incident on the optical modulator 430. Similarly, a vertically polarized beam (represented by a dotted line) outputted from the LD2 505 can be incident on the optical modulator 430 via the lens unit 420.

However, although the LD1 500 and the LD2 5005 are placed adjacently to each other, since the beams are emitted at different positions, this may merely cause different incidence angles.

As described above, when the two beams having the identically modulated luminance values pass through the diaphragm 450, each slit of the diaphragm 450 can have the vertical block filter 470 and the horizontal block filter, respectively, to block the beams, each of which has the polarization direction that is vertical to the pertinent block filter 460 or 470. Accordingly, each beam having a certain polarization direction can pass through the pertinent block filter 460 or 470.

Therefore, as shown in FIG. 4, the two beams having different polarization directions can be overlapped and projected on a screen, to thereby suppress the speckle noises by \sqrt{2} times.

As described with reference to FIG. 2 and FIG. 3, if the optical modulator 430 is the one-dimensional optical modulator, since a one-dimensional video is displayed on a screen, the projection display apparatus can further include a scanning device which can successively scan the one-dimensional video. The scanning device can be placed between the diaphragm 450 and a screen (not shown). A control circuit can control the scanning device to scan two modulation beams vertically to the one-dimensional video. Accordingly, a video having suppressed speckle noise can be outputted on the screen.

Moreover, two beams having the same pixel values can be overlapped on the screen, to thereby increase the luminance of the video.

Hitherto, although some embodiments of the present invention have been shown and described for the above-described objects, it will be appreciated by any person of ordinary skill in the art that a large number of modifications, permutations and additions are possible within the principles and spirit of the invention, the scope of which shall be defined by the appended claims and their equivalents.

1. A projection display apparatus, comprising:
an optical modulator, configured to modulate a luminance of a beam;
light sources in quantities of N, configured to output each beam having different polarization direction, N being a natural number and equal to or greater than 2;
a lens unit, configured to allow each of the beams to be incident on an identical position of the optical modulator at a different incidence angle;
a projection lens, configured to condense each of the N beams modulated and outputted from the optical modulator;
an N-slit diaphragm, configured to allow some of the N beams to pass through the N-slit diaphragm; and
N polarization filters, configured to perform a filtering of the beams having passed through N-slit diaphragm in different polarization directions.

2. The apparatus of claim 1, wherein, if the N is 2, the polarization directions of the beams is vertical to each other.

3. The apparatus of claim 2, wherein the lens unit comprises a condenser lens, and
the two light sources are placed such that each beam outputted from the two light sources passes through a different area in a curved surface of the condenser lens.

4. The apparatus of claim 2, wherein the N-slit diaphragm is a double slit diaphragm, and
the polarization filter is formed in two slits, respectively, to allow a modulation beam having a polarization direction to pass through the polarization filter,
whereas the polarizations direction of the modulation beams passing through the polarization filter are vertical to each other.

5. The apparatus of claim 1, wherein the N light sources output each same color beam having an identical magnitude.

6. A projection display apparatus, comprising
light sources in quantities of N, configured to output each identical beam, N being a natural number and equal to or greater than 2;
a polarization rotating plate, configured to allow N beams outputted from the N light sources to have different polarization directions by polarizing some of the N beams;
an optical modulator, configured to modulate a luminance of an incident beam;
a lens unit, configured to allow the N beams to be incident on an identical position of the optical modulator at a different incidence angle;
a projection lens, configured to condense each of the N beams modulated and outputted from the optical modulator;
an N-slit diaphragm, configured to allow some of the N beams to pass through the N-slit diaphragm; and
N polarization filters, configured to perform a filtering of the beams having passed through N-slit diaphragm in different polarization directions.

7. The apparatus of claim 6, wherein, if the N is 2, the two light sources output each beam having an identical polarization direction, and the polarization rotating plate polarizes one of the two beams in a vertical direction.

8. The apparatus of claim 7, wherein the polarization rotating plate is a half wave plate (HWP).

9. The apparatus of claim 7, wherein the lens unit comprises a condenser lens,
whereas the polarization rotating plate is placed between any one of the two light sources and the lens unit.

10. The apparatus of claim 7, wherein the lens unit comprises a condenser lens, and the two light sources are placed such that each beam outputted from the light sources passes through a different area in a curved surface of the condenser lens,
whereas the polarization rotating plate is placed on a route of a beam passing through one of the different areas.
